(19) United States
(12) Patent Application Publication
(10) Pub. No.: US 2013/0057959 A1
(43) Pub. Date: Mar. 7, 2013

(54) HIGHLY DISPERSIVE OPTICAL ELEMENT WITH BINARY TRANSMISSIBILITY

(71) Applicant: Theodore D. Fay, Mission Viejo, CA (US)

(72) Inventor: Theodore D. Fay, Mission Viejo, CA (US)

(21) Appl. No.: 13/223,956

(22) Filed: Sep. 1, 2011

(51) Int. Cl. G02B 5/02

(52) U.S. Cl. 359/615

(57) ABSTRACT

The current application is directed to a new, highly dispersive optical element that is characterized by binary transmissibility. Various alternative implementations of the new optical element (“NOE”) are fashioned from semiconductor materials, including binary III-V and II-VI semiconductor materials. When applied as components within various optical devices and systems, the NOEs are fashioned to have shapes that provide high dispersion at non-extreme exit angles. The NOEs are additionally coated with multiple anti-reflective coatings which facilitate high transmission, in excess of 90 percent, across a wide range of visible and infrared wavelengths.

### TECHNICAL FIELD

The current application is directed to a new type of optical element with many commercial utilities and, in particular, to a new type of optical element, constructed from doped semiconductor materials, that is highly dispersive over a transmitted range of electromagnetic-radiation wavelengths within a broad range extending from ultraviolet (“UV”) to infrared (“IR”) wavelengths and that is characterized by binary transmissibility, with extremely low transmissibility up to a threshold wavelength, above which the new type of optical element transmits greater than 90 percent of incident radiation.

### BACKGROUND

Optics is a broad and complex field that encompasses many levels of theory, from ray optics, which describes geometrical rules by which rays of light pass through optical systems, to wave optics, which describe light as a scalar function, called the wave function, that obeys a second-order differential equation referred to as the “wave equation,” to electromagnetic optics, based on Maxwell's equations, and finally to quantum optics, based on quantum electrodynamics. Optical devices and instruments, designed according to principles derived from optics theory, include telescopes, microscopes, a wide array of scientific instrumentation, including spectrometers and sensors, cameras, image-display and video-display devices, lighting devices, including car headlights, fiber-optic communications systems, photonics devices and systems used for high-speed and high-bandwidth communications media within computer systems and other processor-based equipment, optical-disk drives, glasses, and many additional devices and instruments. An enormous array of useful and highly efficient optical devices, including many different types of lenses, have been developed and exploited over many hundreds of years to produce the wide array of optic components used in the above-mentioned devices and systems.

While the various levels of optics theory are well developed, there are many remaining challenges associated with optics. Many topics in optics are the objects of ongoing research in university and commercial settings. As one example, a large effort is underway to attempt to produce highly efficient photovoltaic (“PV”) devices commonly referred to as “solar cells.” In most solar-cell-based power-generating systems, a variety of optical elements are used to concentrate sunlight onto semiconductor-based PV cells. Current design efforts are constrained by the characteristics of certain of these optical components. As another example, continuing development of non-imaging fluorescence spectrometers, which record fluorescence-emission intensities from fluorophore-labeled sample molecules excited by ultraviolet light, is being carried out in various research-and-development settings. In non-imaging fluorescence spectrometers, optical components are employed to separate the generally weak longer-wavelength fluorescent-emission signal from a generally high-radiant-flux excitation beam of UV or short-wavelength visible light. The design of non-imaging fluorescence spectrometers is also constrained by available optical components and subsystems. Researchers, designers, manufacturers, and users of various optical devices, components, and systems continue to seek new types of optical components with characteristics that relieve or change the constraints associated with traditional optical components employed in various devices, components, and systems in order to facilitate the development and production of new and/or more capable types of optical devices, components, and systems.

### SUMMARY

The current application is directed to a new, highly dispersive optical clement that is characterized by binary transmissibility. Various alternative implementations of the new optical element (“NOE”) are fashioned from semiconductor materials, including binary III-V and II-VI semiconductor materials. When applied as components within various optical devices and systems, the NOEs are fashioned to have shapes that provide high dispersion at non-extreme exit angles. The NOEs are additionally coated with multiple anti-reflective coatings which facilitate high transmission, in excess of 90 percent, across a wide range of visible and infrared wavelengths.

### BRIEF DESCRIPTION OF THE DRAWINGS

FIGS. 1A-2D illustrate shapes of various implementations of the new optical element to which the current application is directed.

FIG. 3 illustrates the anti-reflective coatings on the optical surface of an NOE.

FIG. 4 illustrates the refractive indexes of the 20 anti-reflective coatings that form the optical interface for one example NOE.

FIGS. 5A-B provide tables of common III-V and II-VI semiconductor materials that may be used for manufacturing NOEs.

FIGS. 6-10 illustrate the concepts of etendue and radiance.

FIGS. 7A-C illustrates computation of the etendue for a light source.

FIG. 8 illustrates calculation of the radiance and basic radiance for a light source.

FIGS. 9A-C illustrate etendue-dependent properties of an optical interface within an optical system.

FIG. 10 illustrates the fact that the overall etendue of an optical system is the minimum etendue of any optical interface within the optical system.

FIG. 11 shows a cross-section of an NOE.

FIG. 12 illustrates one example application for a semiconductor-based NOE.

FIGS. 13B-D illustrate transmission of electromagnetic radiation by a semiconductor-based NOE with respect to wavelength.

FIGS. 14A-B illustrate one possible application of a semiconductor-based NOE used as a filter.

FIGS. 15 and 16 illustrate a second application for semiconductor-based NOEs to which the current application is directed.

### DETAILED DESCRIPTION

The current application is directed to various implementations of a new type of optical element (“NOE”) that can be employed as an optical component within many different types of devices and systems. The various implementations of NOEs may have a variety of different shapes and sizes, with the shapes constrained, in many applications, to provide high dispersion of incident light at relatively modest exit angles. The various different NOE implementations employ numerous anti-reflective coatings to ensure high absorption of incident radiation and high transmissibility of light with wavelengths above a cutoff value. However, below the cutoff value, or threshold wavelength, the NOE exhibits extremely low transmissibility. When the transmissibility of the NOE is plotted with respect to wavelength, the transition between low-transmissibility to high-transmissibility is nearly vertical and the NOE thus exhibits binary transmissibility. It should be noted that, in the current discussion, the term “light” is equivalently to the phrase “electromagnetic radiation with wavelengths in the UV, visible, and infrared bands.”

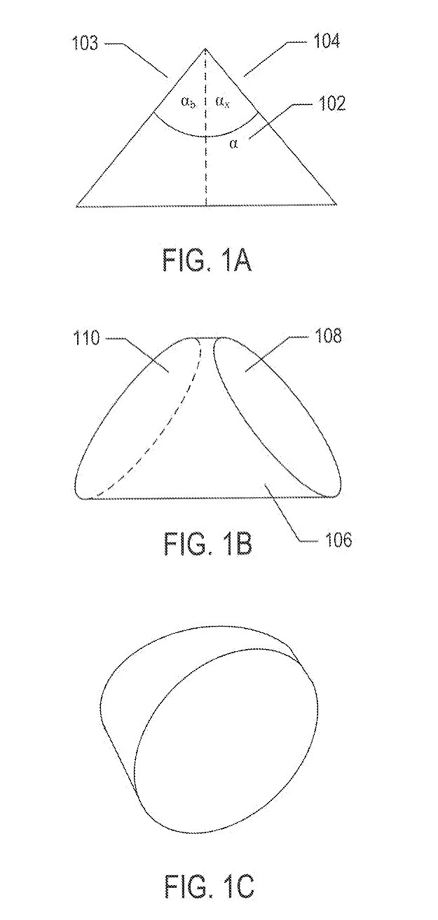

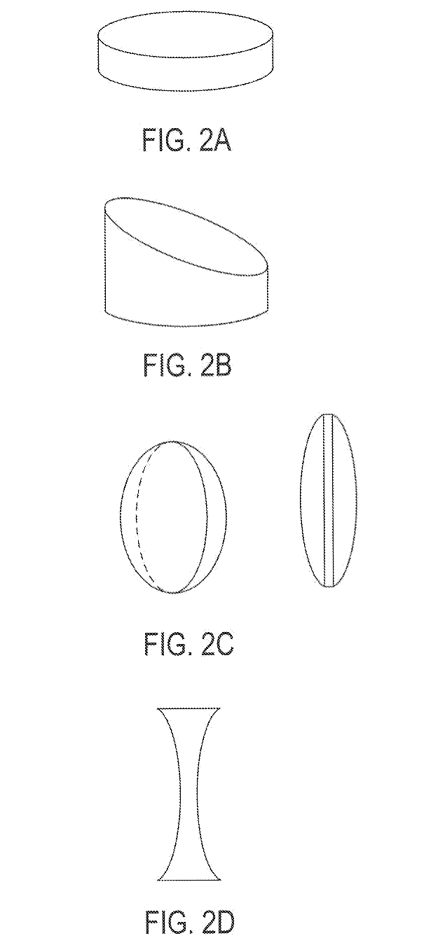

FIGS. 1A-2D illustrate shapes of various implementations of the new optical element to which the current application is directed. FIG. 1A-C show one implementation of the NOE which finds use in solar-power applications. The NOE, in cross-section, is approximately triangular, with an apex angle α=α_{b}+αₓ, as shown in FIG. 1A. In practical embodiments, the NOE may be a cylindrical section 106 with planar faces 108 and 110 oriented at the angle α with respect to one another in a vertical dimension and one horizontal dimension, (z and x in the Cartesian coordinate system), and parallel to one another in a second horizontal dimension y. In cross-section, with the major axis of the cylinder parallel to the plane of the page and directed horizontally, the NOE exhibits a trapezoidal cross-section. FIG. 1C shows a different view of the NOE illustrated in FIG. 1B. For use in various additional applications, NOEs may be regular cylindrical cross-sections, as shown in FIG. 2A, asymmetrical trapezoidal cylinders, as shown in FIG. 2B, and convex and concave lens-shaped optical elements, as shown in FIGS. 2C-D. The sizes of NOEs may range from less than a centimeter to tens of centimeters in the longest dimension. In certain cases, film-like and ribbon-like NOEs may have at least one dimension of up to many meters in length.

As discussed further, below, NOEs are generally fashioned from doped semiconductor materials having indexes of refraction n substantially greater than the index of refraction of air, 1.0, and of glass, 1.5. In order to maximize absorption of incident radiation, the optical surfaces of the NOE, such as the planar surfaces 108 and 110 of the NOE shown in FIG. 1B, are coated with multiple anti-reflective coatings with refractive indices that increase from a refractive index slightly greater than that of the external medium, for the outermost layer, to a refractive index just below that of the NOE material, for the innermost layer. Many different types of antireflective coatings, including thin films and layers of magnesium fluoride and various fluoropolymers, are used as antireflective coatings.

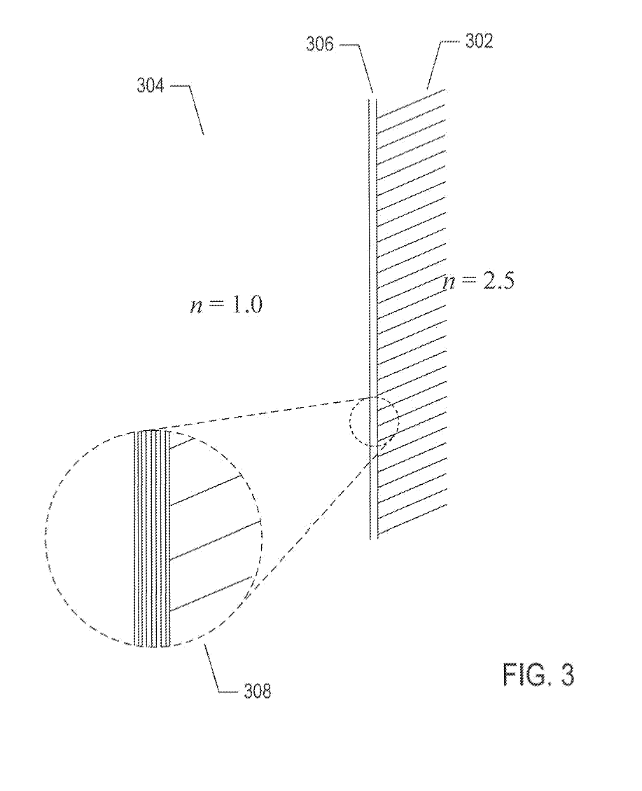

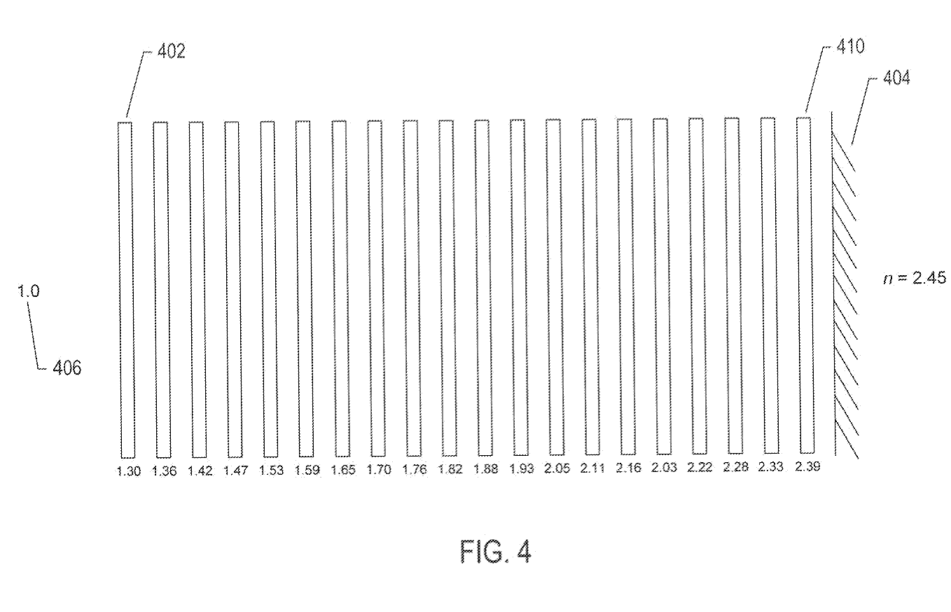

FIG. 3 illustrates the anti-reflective coatings on the optical surface of an NOE. As shown in FIG. 3, the NOE material 302 may have a refractive index n=2.45 while an exterior medium, such as air 304, has a refractive index of n=1.0. The optical interface 306 comprises, as shown in inset 308, multiple anti-reflective coatings. FIG. 4 illustrates the refractive indexes of the 20 anti-reflective coatings that form the optical interface for one example NOE. In FIG. 4, each coating is represented by a thin vertical rectangle, such as thin vertical rectangle 402. They are shown spaced apart, in FIG. 4, for clarity but, when forming the optical interface of an NOE, are layered directly above one another. In FIG. 4, the NOE material 404 has a refractive index of n=2.45 and is represented by cross-hatched lines. As in FIG. 3, the refractive index of the exterior medium 406 is 1.0. The outermost anti-reflective coating 402 has a refractive index of 1.30 while the innermost anti-reflective coating 410 has a refractive index of 2.39. As can be seen in FIG. 4, the refractive indexes of the anti-reflective coatings steadily increase from the outmost anti-reflective coating 402 to the innermost anti-reflective coating 410. While it would be desirable for the anti-reflective coatings to begin, at the outermost layer, with refractive indexes closer to that of air, there are no practical coatings with refractive indexes below 1.30.

Many of the NOEs used in practical applications are employed so that the angle of incidence of light with respect to the input optical interface of the NOE is close to the Brewster's angle for a glass optical element. The Brewster's angle is an angle of incidence at which p-polarized incident light is fully absorbed at the input optical interface of the optical clement. Because the refractive index varies with wavelength of incident light, the Brewster's angle also varies with the wavelength. Assuming an angle of incidence of 58°, which is close to the Brewster's angle for a glass medium and for visible light, a refractive index for the optical-element material can be computed as:

58°=arc tan (n_{optical clement})

n_{optical element}=1.6

This computed refractive index, n_{optical element}, is the median index of refraction for the series of optical coatings. In many cases, this median anti-reflective refractive index turns out to be approximately equal to the square root of the refractive index of the NOE semiconductor material. For example, an NOE manufactured from a semiconductor material having a refractive index n=2.45 has \sqrt{n}=1.57 which is close to the above-computed n_{optical element}=1.6. In order to provide the desired high absorption of incident visible-light radiation, a typical NOE is coated with a sufficient number of anti-reflective coatings having increasing refractive indexes, as shown in FIG. 4, to provide relatively small differences in the refractive index between adjacent coatings so that, over the entire set or number of anti-reflective coatings, the refractive index changes slowly from that of the external medium to that of the NOE material without boundaries across which the refractive index changes by a large differential. In certain NOEs, the maximum difference in refractive index between two adjacent coatings, Δn, is less than 0.15. In other NOEs, the maximum difference in refractive index between two adjacent coatings, Δn, is less than 0.10, and in yet additional NOEs, Δn is less than 0.05.

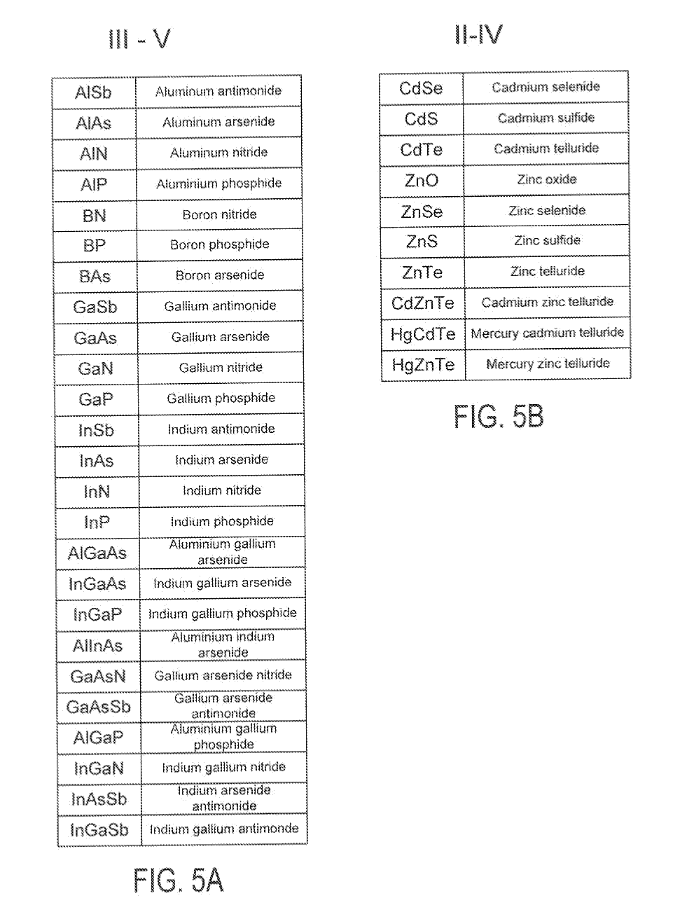

NOEs are generally manufactured from doped semiconductor material. In general, III-V or II-VI binary semiconductors are employed, although semiconductor materials composed of more than two elements may also find use in certain NOE implementations. FIGS. 5A-B provide tables of common III-V and II-VI semiconductor materials that may be used for manufacturing NOEs. Additional suitable semiconductor materials include ThBrI₂, IV-VI telluride oxides, alkali yttrium and I-II-VI lanthanide oxides, and ZnCdTe₂. In addition, NOEs are generally doped with common acceptor or donor dopants, including boron, aluminum, phosphorous, arsenic, antimony, and bismuth. As discussed further, below, the type and concentration of dopants can be used to adjust the slope of the transmission-wavelength curve, discussed below, at the cutoff wavelength that separates the non-transmitted wavelength region from the nearly completely-transmitted wavelength region that characterizes a particular NOE.

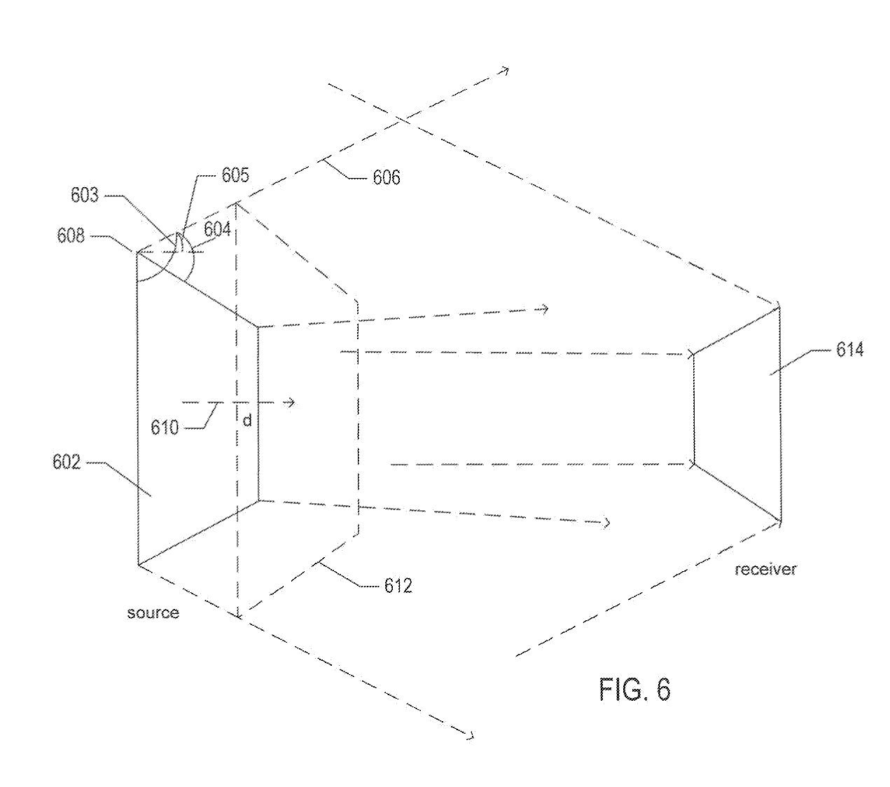

FIGS. 6-10 illustrate the concepts of etendue and radiance. Optical systems can be considered to be a series of interfaces between optical components, one of which transmits light and the other of which receives light. FIG. 6 illustrates one such optical interface. In FIG. 6, a light source is shown as a planar area 602 from which light is transmitted outward through a solid angle that can be defined in terms of the angles 603-605 of the highest-angle ray 606 emitted from a corner 608 of the light-source area 602. In other words, the further away from the light source, the greater the area through which light emitted from the light source passes when light rays emerge from the source that are not perpendicular to the plane of the source and have at least one direction cosine with respect to a dimension parallel to the plane of the source less than zero. For example, in FIG. 6, at a distance d (610 in FIG. 6) from the light source 602, emitted light rays pass through a rectangular area 612 larger than the light-source area 602. Similarly, a receiving optical component is represented in FIG. 6 by a second rectangular area 614 which is capable of receiving light over a second solid angle. The area of a light source or light receiver and the solid angle over which light is emitted or received, respectively, from the light source or light receiver, is related to the radiant flux emitted by the light source and received by the receiver.

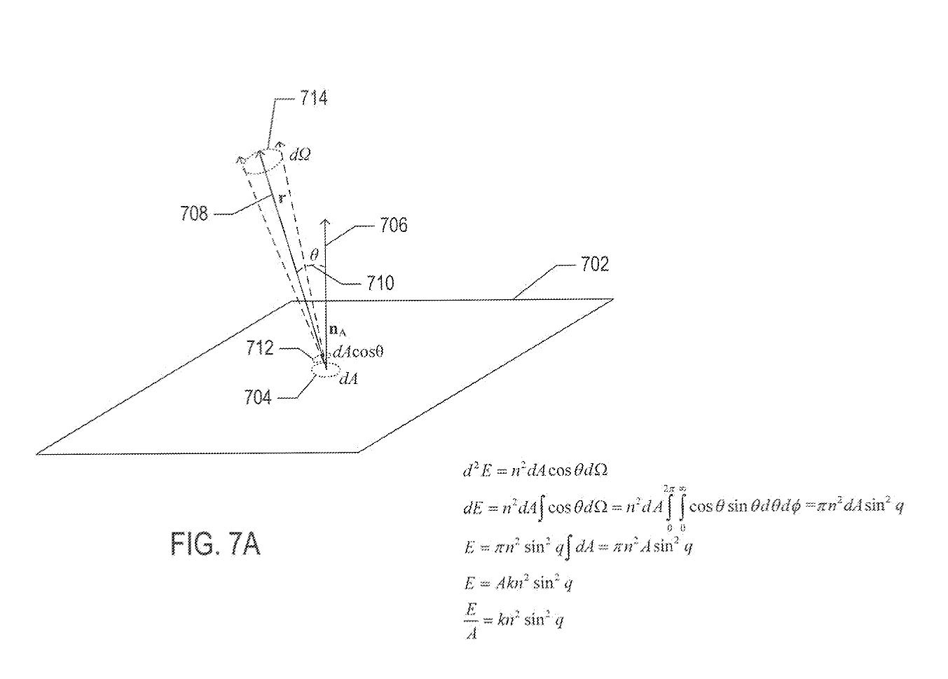

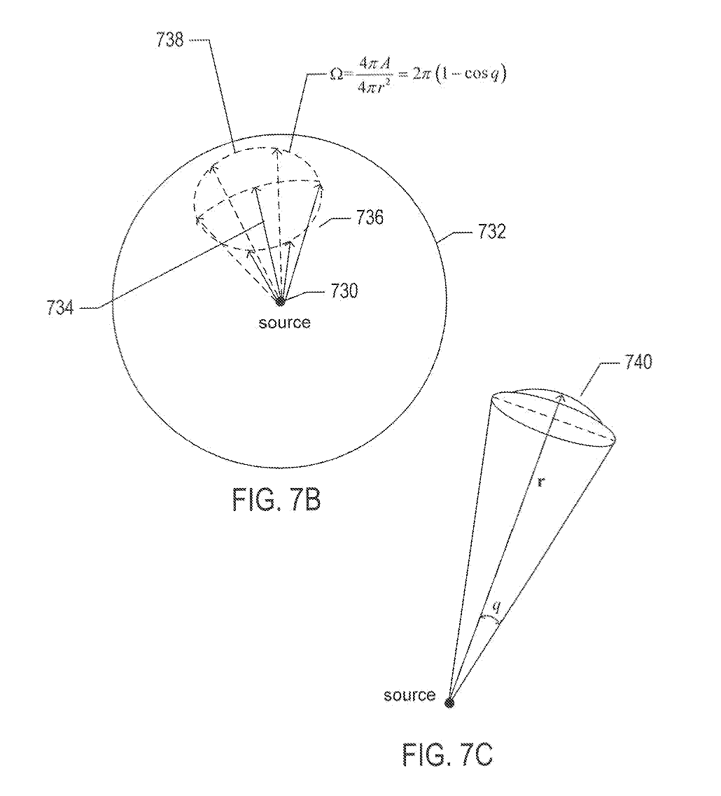

FIGS. 7A-C illustrates computation of the etendue for a light source. FIG. 7A illustrates computation of the etendue for a light source. The etendue of a light receiver can be similarly computed. The etendue, E, is a geometric quantity representative of the flux-emission or flux-gathering capability of an optical component. As shown in FIG. 7A, the etendue is computed by integration over infinitesimal areas and infinitesimal solid angles with respect to the area of the light source and solid angle over which light is emitted from the light source. In FIG. 7A, the light source is represented by a rectangular area 702. An infinitesimal disk-shaped area of the surface 704, dA, is shown in FIG. 7A by a circular dashed line with normal direction n_{A} 706 perpendicular to the plane of the light source. A direction represented by vector r 708 is considered, where r is inclined with respect to n_{A} by angle θ710. The effective area of the light source in the direction r is represented in FIG. 7A by dashed circle 712, dA cos θ, perpendicular to r. Assuming that light is emitted from this effective area through an infinitesimal solid angle dΩ, represented in FIG. 7A by dashed circle 714, the etendue E for light crossing infinitesimal area dA in the direction r through solid angle dΩ is expressed as:

d²E=n²dA cos θdΩ

where n is the refractive index of the medium into which the light is emitted. Integrating this expression over the solid angle defined by a maximum angular aperture q for light emission provides an expression:

$$\begin{matrix}dE = {n}^{2} dA \int cos θ d Ω = {n}^{2} dA {\int }_{0}^{2 π} {\int }_{0}^{∞} cos θ sin θ d θ d φ \\ = π {n}^{2} dA {sin}^{2} q .\end{matrix}$$

where the single integral over the solid angle is transformed to a double integral over the spherical-coordinate dimensions θ and φ. Integrating this expression over the area of the light source then provides an expression for the etendue of the light source:

E=πn² sin² q∫dA=πnA sin² q.

Thus, the etendue of the light source can be expressed as:

$$E = {Akn}^{2} {sin}^{2} q$$

$$\frac{E}{A} = {kn}^{2} {sin}^{2} q$$

where A is the area of the light source, k is a constant, n² is the square of the refractive index of the median into which the light is emitted, and q is the angular aperture, or maximum value of θ, for the light source.

FIGS. 7B-7C illustrate the solid angle S1 and the angular aperture, or half-acceptance angle, q. In FIG. 7B, an illumination source 730 is shown at the center of a sphere 732. A vector r 734 represents a direction of illumination from the illumination source outward. The magnitude of the vector r, |r|, is equal to the radius of the sphere r. Light is emitted from the illumination source within a cone 736 that intersects the sphere along the circular dashed line 738. The cone of light emission is shown in a different view in FIG. 7C, where the half-acceptance angle q is the angle between the vector r and the surface of the cone. The solid angle corresponding to this emission cone Ω is equal to the area, A_{q}, of the spherical cap 740 formed from the surface of the sphere intersected by the cone multiplied by 4π and divided by the total surface area of the sphere, or:

$$Ω = \frac{4 π A}{4 π {r}^{2}} = 2 π ( 1 - cos q ) .$$

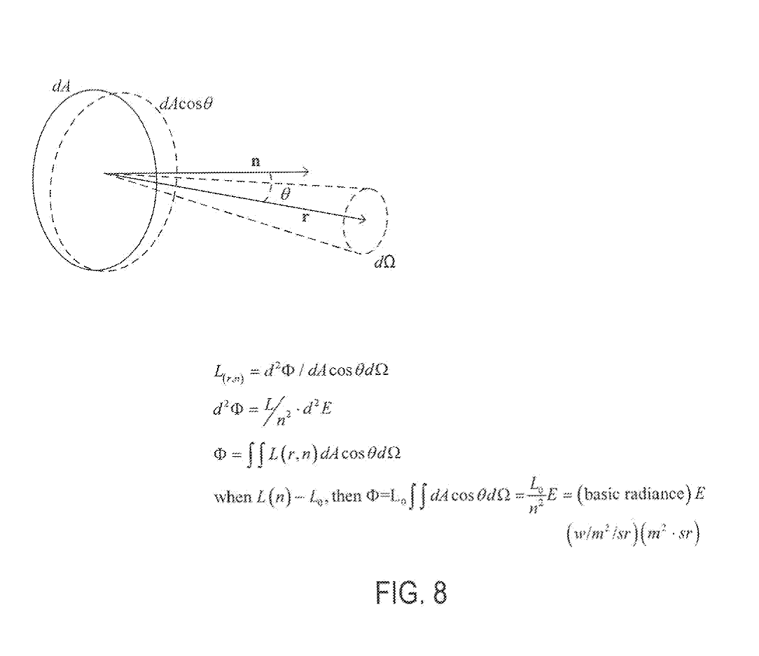

FIG. 8 illustrates calculation of the radiance and basic radiance for a light source. FIG. 8 uses similar graphical and notational conventions as used in FIG. 7. The source radiance is computed by integration over infinitesimal source areas dA 802 in the normal direction n 804 over directions, such as that represented by vector r 806, within an infinitesimal solid angle dΩ 808. The radiance at point r in a direction normal to the infinitesimal surface of the light source is:

L_{(r,n)}=d²Φ/dA cos θdΩ

where φ is the total power transmitted by the light source, computed from this expression as:

Φ=∫∫L(r,n)dA cos θdΩ.

When the light source is uniform and Lambertian, or, in other words, the radiance L₀ is independent of viewing angle, then the power emitted by the light source is:

$$\begin{matrix}Φ = {L}_{0} \int \int dA cos θ d Ω = \frac{{L}_{0}}{{n}^{2}} E \\ = ( basic radiance ) E .\end{matrix}$$

where the units for the product of basic radiance and E are (w/m²/sr)(m²·sr). Thus, the power emitted by the light source is the product of the etendue and the basic radiance, or intensity, of the light source.

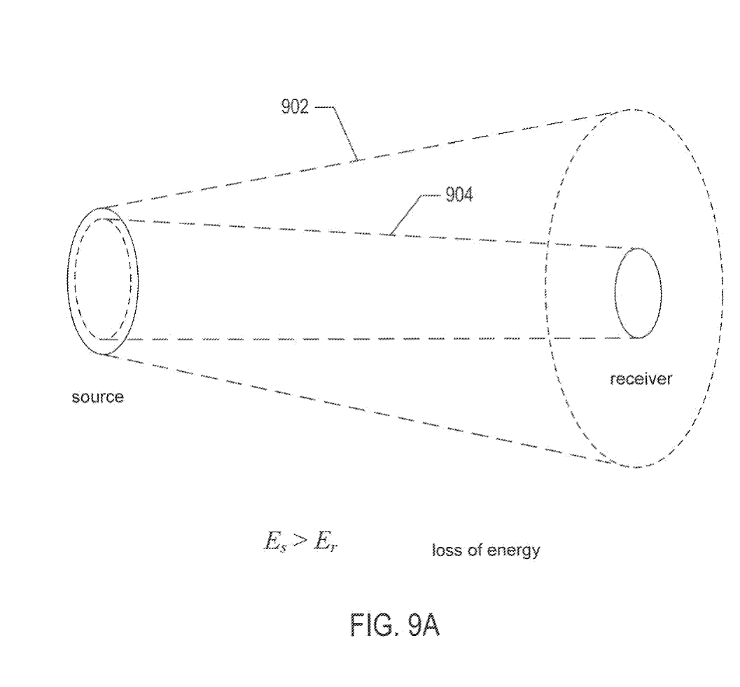

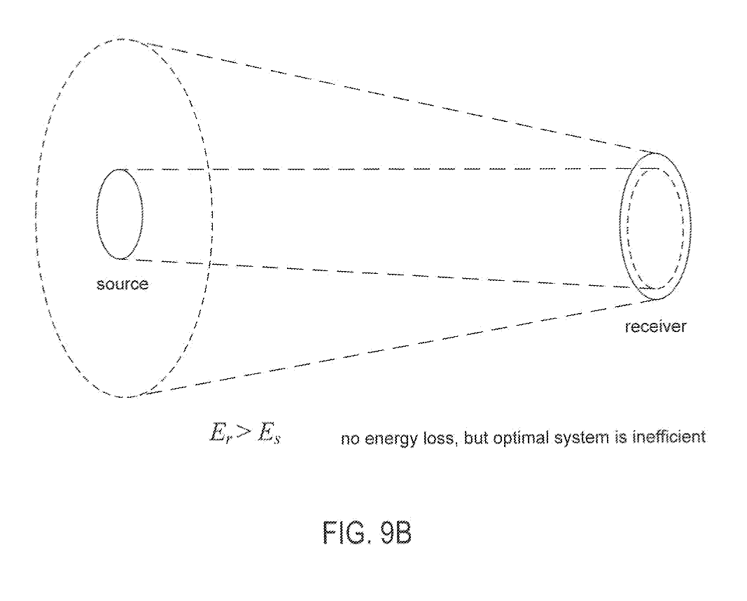

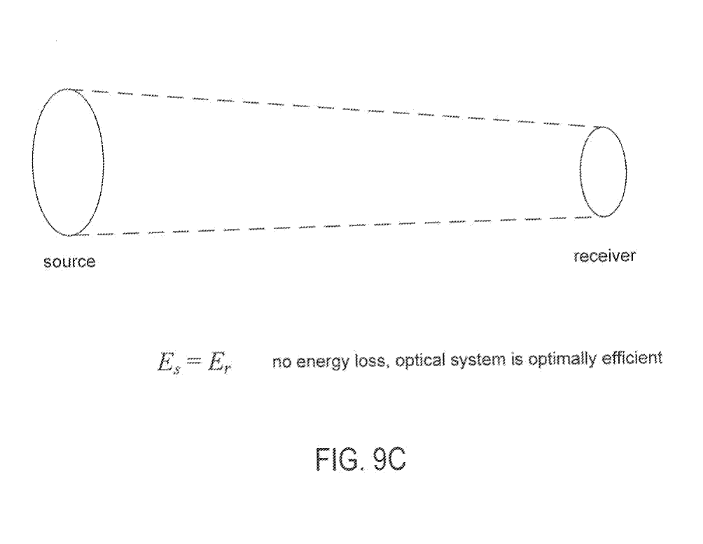

FIGS. 9A-C illustrate etendue-dependent properties of an optical interface within an optical system. As shown in FIG. 9, when the etendue of the source, Eₛ, represented by the dashed-line cone 902, is greater than the etendue of the receiver, represented by dashed-line cone 904, there is a loss of energy through the optical interface. In other words, a source is emitting light over a greater solid angle and/or from a greater source area than can be fully captured by the receiver. Thus, when Eₓ>Eᵣ, light energy is lost through the interface, generally decreasing the efficiency of the optical system. FIG. 9B shows an opposite case, in which Eᵣ>Eₛ, using the same illustration conventions as used in FIG. 9A. In this case, no energy is lost through the optical interface, but the optical system is nonetheless inefficient, since, in general, the flux-gathering capacity of the receiver is partially wasted. In general, increasing the flux-gathering capacity of the receiver involves increased costs and/or design efforts. When, as shown in FIG. 9C, Eₛ=Eᵣ for an optical interface, then light energy is not lost and the optical interface is near-optimally or optimally efficient.

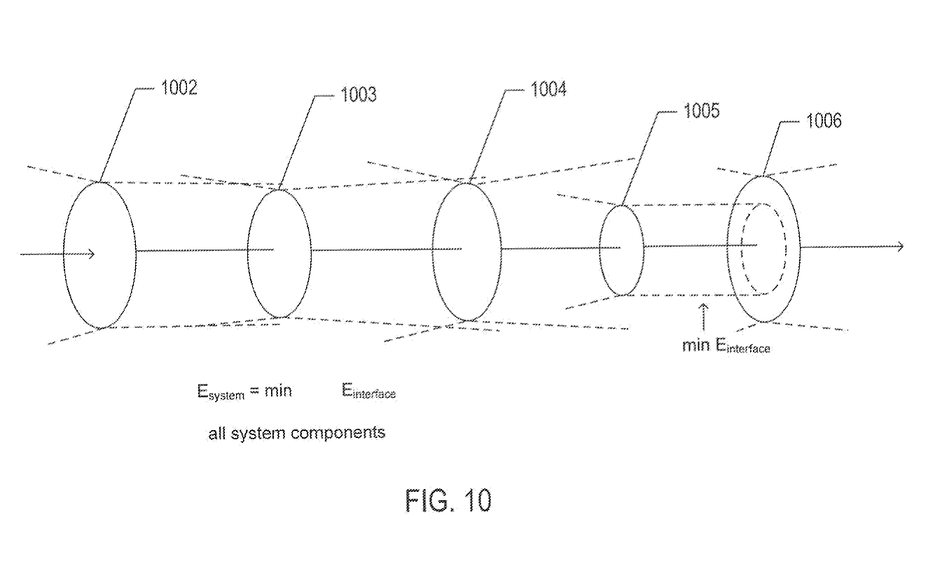

FIG. 10 illustrates the fact that the overall etendue of an optical system is the minimum etendue of any optical interface within the optical system. In FIG. 10, the etendues of optical components 1002-1005 are well matched, but for the optical interface comprising optical components 1005 and 1006, Eₛ<Eᵣ, and thus light energy is lost through this interface. The etendue for this interface is thus the minimum etendue for any interface within the system, the system etendue is thus the etendue of this minimum interface.

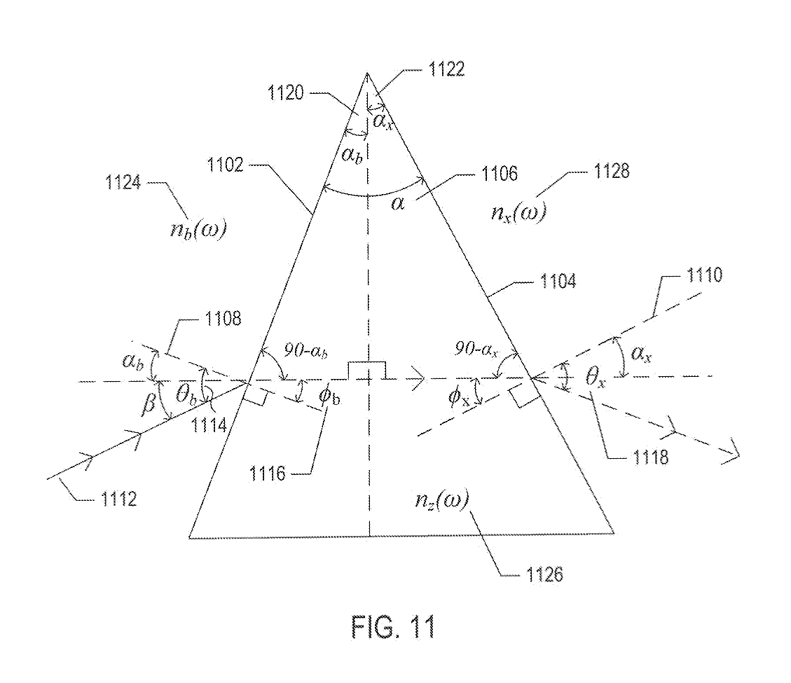

FIG. 11 shows a cross-section of an NOE. As discussed above, the NOE may be cylindrical, with two planar surfaces angled with respect to one another, as shown in FIGS. 1B-C. In the cross-section of the NOE shown in FIG. 11, side 1102 represents the input optical surface and side 1104 represents the output optical surface. The apex angle for the NOE is a 1106. Dashed line 1108 is normal to the input surface 1102 and dashed line 1110 is normal to the output optical surface 1104. An incident light ray 1112 impinges on the input optical surface 1102 with an angle of incidence θ_{b} 1114. The ray enters the NOE material with an angle of refraction φ_{b} 1116 and exits the output optical surface 1104 with an output angle θₓ 1118. FIG. 11 illustrates relationships between the above-mentioned angles and the angles α_{b} 1120 and αₓ 1122 that together compose the apex angle α 1106. The external medium on the input side has a refractive index n_{b}(ω) 1124, the index of refraction of the cone material is n_{z}(ω) 1126, and the index of refraction of the external medium on the output side of the NOE is nₓ(ω) 1128. The notation n(ω) indicates that n is dependent on the wave number of the light in the medium with refractive index n(ω).

The following relationships are derived from FIG. 11 by simple trigonometry and Snell's Law:

α=α_{b}+αₓ=φ_{b}+φₓ

n_{b} sin θ_{b}=n_{z} sin φ_{b}

nₓ sin θₓ=n_{z} sin φₓ

nₓ sin θₓ=sin(α_{b}+αₓ−φ_{b})

Then, given n_{b}=nₓ and defining

$${n}^{′} = \frac{{n}_{z}}{{n}_{b}} = \frac{{n}_{z}}{{n}_{x}} ,$$

an expression for sin θₓ can be derived as follows:

$$\begin{matrix}sin {θ}_{x} = \frac{{n}_{z}}{{n}_{x}} sin ( {α}_{b} + {α}_{x} - {φ}_{b} ) \\ = {n}^{′} [ sin ( {α}_{b} + {α}_{x} ) cos {φ}_{b} - cos ( {α}_{b} + {α}_{x} ) sin {φ}_{b} ] \\ = {n}^{′} [ sin ( {α}_{b} + {α}_{x} ) \sqrt{1 - {sin}^{2} {φ}_{b}} ] - {n}^{′} sin {φ}_{b} cos ( {α}_{b} + {α}_{x} ) \\ = {n}^{′} [ sin ( {α}_{b} + {α}_{x} ) \sqrt{1 - {( \frac{1}{{n}^{′}} sin {φ}_{b} )}^{2}} ] - {n}^{′} ( \frac{1}{{n}^{′}} sin {φ}_{b} ) cos ( {α}_{b} + {α}_{x} ) \\ = {n}^{′} [ sin ( {α}_{b} + {α}_{x} ) {( 1 - \frac{{sin}^{2} {φ}_{b}}{{( {n}^{′} )}^{2}} )}^{1 / 2} ] - sin {φ}_{b} cos ( {α}_{b} + {α}_{x} )\end{matrix}$$

As discussed above, a general expression for etendue is:

E=kn² sin² g.

The etendue for the NOE is shown in FIG. 11 and can be expressed as:

E_{NOE}=K(NA)²≡K(n′ sin θₓ)²

where NA is the numerical aperture for the NOE, n′ sin θₓ, is a commonly computed parameter related to the light-gathering power of an optical element; and

K is a constant that is, in part, determined by the design characteristics of the NOE and is approximately equal to π.

Note that K includes the area A and other parameters related to the physical characteristics of the NOE, which are not included in the constant k, used in the first equation for etendue.

Using the above-provided expressions, the etendue for the NOE, E_{NOE}, can be computed as:

$$\begin{matrix}\begin{matrix}\begin{matrix}{E}_{NOE} = {K ( {n}^{′} )}^{2} {sin}^{2} {θ}_{r} \\ = {{K ( {n}^{′} )}^{2} [ {n}^{′} sin ( {α}_{b} + \text{?} ) ( 1 - \frac{{sin}^{2} \text{?}}{{( {n}^{′} )}^{2}} ) - sin {θ}_{b} cos ( {α}_{b} + \text{?} ) ]}^{2} \\ = {K ( {n}^{′} )}^{2} [ \begin{matrix}{( {n}^{′} )}^{2} {sin}^{2} ( {α}_{b} + \text{?} ) ( 1 - \frac{{sin}^{2} \text{?}}{{( {n}^{′} )}^{2}} ) - 2 {n}^{′} sin ( {α}_{b} + \text{?} ) \\ {( 1 - \frac{{sin}^{2} {θ}_{b}}{{( {n}^{′} )}^{2}} )}^{1 / 2} sin {θ}_{b} cos ( {α}_{b} + \text{?} ) + {sin}^{2} {θ}_{b} {cos}^{2} ( {α}_{b} + \text{?} )\end{matrix} ]\end{matrix} & \end{matrix} & \\ {π ( NA )}^{2} \approx π [ \begin{matrix}{( {n}^{′} )}^{4} {sin}^{2} ( {α}_{b} + \text{?} ) - {( {n}^{′} )}^{2} {sin}^{2} ( {α}_{b} + \text{?} ) {sin}^{2} {θ}_{b} - 2 {( {n}^{′} )}^{3} \\ sin {θ}_{b} cos ( {α}_{b} + \text{?} ) {( 1 - \frac{{sin}^{2} {θ}_{b}}{{( {n}^{′} )}^{2}} )}^{1 / 2} + {( {n}^{′} )}^{2} {sin}^{2} {θ}_{b} {cos}^{2} ( {α}_{b} + \text{?} )\end{matrix} ] \approx π [ \begin{matrix}{( {n}^{′} )}^{4} {sin}^{2} ( {α}_{b} + \text{?} ) + {( {n}^{′} )}^{2} {sin}^{2} {θ}_{b} ( 1 - 2 {sin}^{2} ( {α}_{b} + \text{?} ) ) - {( {n}^{′} )}^{3} \\ sin ( 2 ( {α}_{b} + \text{?} ) ) sin {{θ}_{b} ( 1 - \frac{{sin}^{2} {θ}_{b}}{{( {n}^{′} )}^{2}} )}^{1 / 2}\end{matrix} ] \\ {π ( NA )}^{2} \approx \text{?} ≅ π [ \begin{matrix}{( {n}^{′} )}^{4} {sin}^{2} ( {α}_{b} + \text{?} ) - {( {n}^{′} )}^{3} sin ( 2 ( {α}_{b} + \text{?} ) ) sin {θ}_{b} \\ {( 1 - \frac{{sin}^{2} {θ}_{b}}{{( {n}^{′} )}^{2}} )}^{1 / 2} + {( {n}^{′} )}^{2} {sin}^{2} {θ}_{b} ( 1 - 2 {sin}^{2} ( {α}_{b} + \text{?} ) )\end{matrix} ] \\ \text{?} \text{indicates text missing or illegible when filed} & \end{matrix}$$

Note that, in the above derivation, the, index of refraction is treated as a constant, rather than as a function of wavelength or wave number. The values, provided below, assume visible-wavelength light with the indexes of refraction relatively constant over a range of visible-light wavelengths.

Using this expression, etendue values for an NOE with an index of refraction of 2.45, an angle of incidence of θ_{b} of 58°, and various apex angles can be calculated and compared with the etendue for a similar glass prism with an index of refraction of 1.5, angle of incidence of 48°, and various apex angles. The results are shown below in Table 1:

TABLE 1

| | n′ | a_{b} + aₓ | θ_{b} | π(NA)² |
|---|---|---|---|---|
| NOE | 2.45 | 44° | 58° | 18.35 |
| | 2.45 | 40° | 58° | 12.91 |
| | 2.45 | 36° | 58° | 8.33 |
| Glass | 1.62 | 58° | 48° | 5.63 |
| | 1.62 | 54° | 48° | 4.36 |
| | 1.62 | 50° | 48° | 3.21 |

As is immediately apparent from the values in the final column of this table, the etendue for the NOE is significantly greater, by a factor of approximately 3, than the etendue for a corresponding glass prism. Thus, the radiant-flux-gathering capability of an NOE is significantly greater than a similarly shaped glass prism. In many applications, such as solar energy applications, increasing the radiant-flux gathering ability of a NOE provides increased performance of a NOE with respect to a glass prism or other optic with lower etendue. In other applications, an increased etendue may not be desirable, and in those applications, materials and design changes, informed by the above analysis, can be used to produce a NOE-like optical element with desired etendue suitable for the other applications. Also, the dependence of etendue on apex angle is greater for the NOE than for glass, providing a more sensitive tunable design parameter for designing particular NOEs for particular applications than available when using glass.

Next, the partial derivatives of the etendue with respect to various variables, including the refractive index of the NOE, the angle of incidence to the NOE, and the wave number w of the incident electromagnetic radiation can be calculated for a semiconductor NOE with index of refraction 2.45 and compared to the partial derivatives of the etendue with respect to the various variables for a similar glass prism with an index of refraction of 1.5. These partial derivitives provide a basis for comparing properties of NOEs to those of glass optical elements and also provide indications of design parameters that can be manipulated by designers of NOEs for various applications.

First, the partial derivative of etendue with respect to refractive index is derived as:

$$\begin{matrix}\begin{matrix}\frac{\partial {π ( NA )}^{2}}{\partial \text{?}} = \frac{\partial {π ( NA )}^{2}}{\partial ( {n}^{′} )} \frac{d ( {n}^{′} )}{d \text{?}} \\ = \frac{\partial }{\partial ( {n}^{′} )} π [ \begin{matrix}{( {n}^{′} )}^{4} {sin}^{2} ( {α}_{b} + \text{?} ) - \text{?} sin ( 2 ( {α}_{b} + \text{?} ) ) sin {θ}_{b} \\ {( 1 - \frac{{sin}^{2} {θ}_{b}}{{( {n}^{′} )}^{2}} )}^{1 / 2} + {( {n}^{′} )}^{2} {sin}^{2} {θ}_{b} ( 1 - 2 {sin}^{2} ( {α}_{b} + \text{?} ) )\end{matrix} ] \\ \frac{d ( {n}^{′} )}{d \text{?}} \\ = π [ \begin{matrix}4 ( \text{?} ) {sin}^{2} ( {α}_{b} + \text{?} ) - 3 {( {n}^{′} )}^{2} sin ( 2 ( {α}_{b} + \text{?} ) ) sin {θ}_{b} \\ {( 1 - \frac{{sin}^{2} {θ}_{b}}{{( {n}^{′} )}^{2}} )}^{1 / 2} - {( {n}^{′} )}^{3} sin ( 2 ( {α}_{b} + \text{?} ) ) sin {θ}_{b} \frac{1}{2} \\ {( 1 - \frac{{sin}^{2} {θ}_{b}}{{( {n}^{′} )}^{2}} )}^{- 1 / 2} ( 1 - {sin}^{2} {θ}_{b} ) ( - 2 ) \frac{1}{\text{?}} + 2 ( {n}^{′} ) {sin}^{2} {θ}_{b} \\ ( 1 - 2 {sin}^{2} ( {α}_{b} + \text{?} ) )\end{matrix} ] \frac{1}{{n}_{b}} \\ = π [ \begin{matrix}4 ( \text{?} ) {sin}^{2} ( {α}_{b} + \text{?} ) - 3 {( {n}^{′} )}^{2} sin ( 2 ( {α}_{b} + \text{?} ) ) sin {θ}_{b} \\ {( 1 - \frac{{sin}^{2} {θ}_{b}}{{( {n}^{′} )}^{2}} )}^{1 / 2} + 2 ( {n}^{′} ) {sin}^{2} {θ}_{b} ( 1 - 2 {sin}^{2} ( {α}_{b} + \text{?} ) ) + \\ sin ( 2 ( {α}_{b} + \text{?} ) ) sin {{θ}_{b} ( 1 - \frac{{sin}^{2} {θ}_{b}}{{( {n}^{′} )}^{2}} )}^{- 1 / 2} ( 1 - {sin}^{2} {θ}_{b} )\end{matrix} ] \frac{1}{{n}_{b}}\end{matrix} \\ \text{?} \text{indicates text missing or illegible when filed}\end{matrix}$$

Using numerical values for the various parameters indicated below, in Table 2, numeric values for various NOEs and glass prisms can be computed, and are provided in Table 2, below:

TABLE 2

| | n′ | n_{b} | α_{b} + αₓ | θ_{b} | $\frac{\partial {π ( NA )}^{2}}{\partial {n}_{x}}$ |
|---|---|---|---|---|---|
| NOE | 2.45 | 1.0 | 44 | 58 | 82.61 |
| | 2.45 | 1.0 | 40 | 58 | 71.43 |
| | 2.45 | 1.0 | 36 | 58 | 60.66 |
| Glass | 1.62 | 1.0 | 58 | 48 | 31.40 |
| | 1.62 | 1.0 | 54 | 48 | 28.40 |
| | 1.62 | 1.0 | 50 | 48 | 25.38 |

As can be seen by the computed values for the partial derivative of etendue with respect to the refractive index of the optical element, the rate of change of etendue with respect to refractive index is significantly larger for a semiconductor NOE than for a similar glass prism, by a factor of about 2.5. Thus, when designing an NOE, the designer has far greater latitude in selecting materials that provide a desired index of refraction than a designer of traditional glass optical elements. There are many different types of glasses, including some with substantially higher indexes of refraction than 1.5, but, even were one of the higher-index-of-refraction types of glasses chosen, it would not be possible to achieve the magnitudes of etendue achievable using a semiconductor NOE.

The partial derivative of the etendue with respect to angle of incidence can be computed as:

$$\begin{matrix}\begin{matrix}\frac{\partial {π ( NA )}^{2}}{\partial \text{?}} = \frac{\partial }{\partial \text{?}} π [ \begin{matrix}{( {n}^{′} )}^{4} {sin}^{2} ( {α}_{b} + \text{?} ) - ( \text{?} ) sin ( 2 ( {α}_{b} + \text{?} ) ) sin {θ}_{b} \\ {( 1 - \frac{{sin}^{2} {θ}_{b}}{{( {n}^{′} )}^{2}} )}^{1 / 2} + {( {n}^{′} )}^{2} {sin}^{2} {θ}_{b} ( 1 - 2 {sin}^{2} ( {α}_{b} + \text{?} ) )\end{matrix} ] \\ = π [ \begin{matrix}( \text{?} ) sin ( 2 ( {α}_{b} + \text{?} ) ) ( \begin{matrix}cos {{θ}_{b} ( 1 - \frac{{sin}^{2} {θ}_{b}}{{( {n}^{′} )}^{2}} )}^{1 / 2} + \\ sin {θ}_{b} \frac{1}{2} {( 1 - \frac{{sin}^{2} {θ}_{b}}{{( {n}^{′} )}^{2}} )}^{- 1 / 2} - \frac{2}{{( {n}^{′} )}^{2}} \\ {sin}^{2} {θ}_{b} {cos}^{2} \text{?}\end{matrix} ) + \\ {( {n}^{′} )}^{2} ( 1 - 2 {sin}^{2} ( {α}_{b} + \text{?} ) ) 2 sin {θ}_{b} cos {θ}_{b}\end{matrix} ] \\ = π [ \begin{matrix}- ( \text{?} ) sin ( 2 ( {α}_{b} + \text{?} ) ) ( \begin{matrix}cos {{θ}_{b} ( 1 - \frac{{sin}^{2} {θ}_{b}}{{( {n}^{′} )}^{2}} )}^{1 / 2} - \\ \frac{sin ( 2 {θ}_{b} )}{{( {n}^{′} )}^{2}} \frac{sin {θ}_{b}}{2} {( 1 - \frac{{sin}^{2} {θ}_{b}}{{( {n}^{′} )}^{2}} )}^{- 1 / 2}\end{matrix} ) + \\ {( {n}^{′} )}^{2} ( 1 - 2 {sin}^{2} ( {α}_{b} + \text{?} ) ) sin 2 {θ}_{b}\end{matrix} ]\end{matrix} \\ \text{?} \text{indicates text missing or illegible when filed}\end{matrix}$$

This expression can be used to compute numerical values of the partial derivative of the etendue with respect to angle of incidence for various NOEs and corresponding glass prisms, which are included below in Table 3:

TABLE 3

| | n′ | α_{b} + αₓ | θ_{b} | $\frac{\partial {π ( NA )}^{2}}{\partial {θ}_{b}}$ |
|---|---|---|---|---|
| NOE | 2.45 | 44° | 58° | −8.500 |
| | 2.45 | 40° | 58° | −4.84 |
| | 2.45 | 36° | 58° | −1.27 |
| Glass | 1.62 | 58° | 48° | −9.52 |
| | 1.62 | 54° | 48° | −7.92 |
| | 1.62 | 50° | 48° | −6.26 |

The rate of change of etendue with respect to the angle of incidence is more sensitive to the apex angle for the semiconductor NOE than for the corresponding glass prism. As with etendue, the sensitivity of the rate of change of etendue with respect to the angle of incidence to apex angle provides a more sensitive tunable design parameter for designing particular NOEs for particular applications than available when using glass.

An expression for the partial derivative of the etendue with respect to wave number can be computed as:

$$\begin{matrix}\begin{matrix}\frac{\partial {π ( NA )}^{2}}{\partial ω} = \frac{\partial {π ( NA )}^{2}}{\partial {n}_{z}} \frac{\partial {n}_{z}}{\partial ω} + \frac{\partial {π ( NA )}^{2}}{\partial {θ}_{b}} \frac{\partial {θ}_{b}}{\partial ω} + \frac{\partial {π ( NA )}^{2}}{\partial ( {α}_{b} + {α}_{x} )} \frac{\partial ( {α}_{b} + {α}_{x} )}{\partial ω} \\ = \frac{\partial {π ( NA )}^{2}}{\partial {n}_{z}} \frac{\partial {n}_{z}}{\partial ω}\end{matrix} & \\ {n}_{z}^{2} ( λ ) = A + \frac{B}{1 - {C}^{2} {ω}^{2}} \\ {n}_{z} = \sqrt{A + \frac{B}{1 - {C}^{2} {ω}^{2}}} \\ \frac{\partial {n}_{z}}{\partial ω} = \frac{{BC}^{2} ω}{{{n}_{z} ( 1 - {C}^{2} {ω}^{2} )}^{2}} \\ \frac{\partial {π ( NA )}^{2}}{\partial ω} = \frac{{BC}^{2} ω}{{{n}_{z} ( 1 - {C}^{2} {ω}^{2} )}^{2}} \frac{\partial {π ( NA )}^{2}}{\partial {n}_{z}} & \end{matrix}$$

One form of the Sellmeier equation, with Sellmeier coefficients A, B, and C, is used in this derivation. The partial of etendue with respect to wave number is related to the partial of etendue with respect to index of refraction by a complex multiplier that includes the Sellmeier coefficients A, B, and C as well as the wave number ω. This multiplier term is computed for a semiconductor NOE and a corresponding glass prism, respectively, as shown in Table 4, below:

TABLE 4

| | A | B | C | ω | $\frac{{BC}^{2} ω}{{{n}_{2} ( 1 - {C}^{2} {ω}^{2} )}^{2}}$ |
|---|---|---|---|---|---|
| NOE | 2.26 | 2.86 | .228 | 1 | .072014 |
| | | | | 2 | .195612 |
| | | | | 3 | .570045 |
| Glass | 1.45 | 0.80 | 0.10 | 1 | .005432 |
| | | | | 2 | .011489 |
| | | | | 3 | .018990 |

Thus, the ratio of a partial derivative with respect to wave number for the NOE and a corresponding glass prism can be computed as the ratio of the multiplier, shown in Table 4, times the ratio of the partial derivatives of etendue with respect to index of refraction for the semiconductor NOE and a corresponding glass prism, as follows:

$$\frac{{\frac{\partial {π ( NA )}^{2}}{\partial ω} }_{noe}}{{\frac{\partial {π ( NA )}^{2}}{\partial ω} }_{glass}} = \frac{0.1956}{0.01149} \frac{{\frac{\partial {π ( NA )}^{2}}{\partial {n}_{z}} }_{noe}}{{\frac{\partial {π ( NA )}^{2}}{\partial {n}_{z}} }_{glass}}$$

As one example, using an NOE with an apex angle of 44° and an angle of incidence of 58° and a corresponding glass prism with an apex angle of 58° and an angle of incidence of 48°, assuming tallow-orange visible light with wave number=2, the ratio of partial derivative of the etendue with respect to wave number for the NOE to the partial derivative of etendue with respect to wave number for the corresponding glass prism is 62:

### EXAMPLE

$$\frac{{\frac{\partial π ( NA )}{\partial ω} }_{noe ( {α}_{b} + {α}_{x} = 44 , {θ}_{b} = 58 )}^{2}}{{\frac{\partial π ( NA )}{\partial ω} }_{glass ( {α}_{b} + {α}_{x} = 58 , {θ}_{b} = 48 )}^{2}} = \frac{0.1956}{0.01149} \frac{82.61}{31.40} = 44.8$$

This large ratio is reflective of the fact that a semiconductor NOE exhibits far greater dispersion of incident light with respect to wave number or wave length than a corresponding glass prism. The greater dispersion, like greater etendue, may or may not be desirable for specific applications. For imaging applications, the greater dispersion with respect to wave number of the incident light provides for potentially greater imaging resolution. In solar applications, the greater dispersion is of great beneficial significance, as discussed below.

Finally, an expression for the partial derivative of the etendue with respect to half-acceptance angle, q, can be computed as:

$$\frac{\partial E}{\partial q} = \frac{\partial {Kn}^{2} {sin}^{2} q}{\partial q} = 2 {Kn}^{2} sin q cos q$$

In one example NOE,

$$\frac{\partial E}{\partial q}$$

for the NOE is approximately 0.5 versus a

$$\frac{\partial E}{\partial q}$$

for a similar glass prism of 0.015.

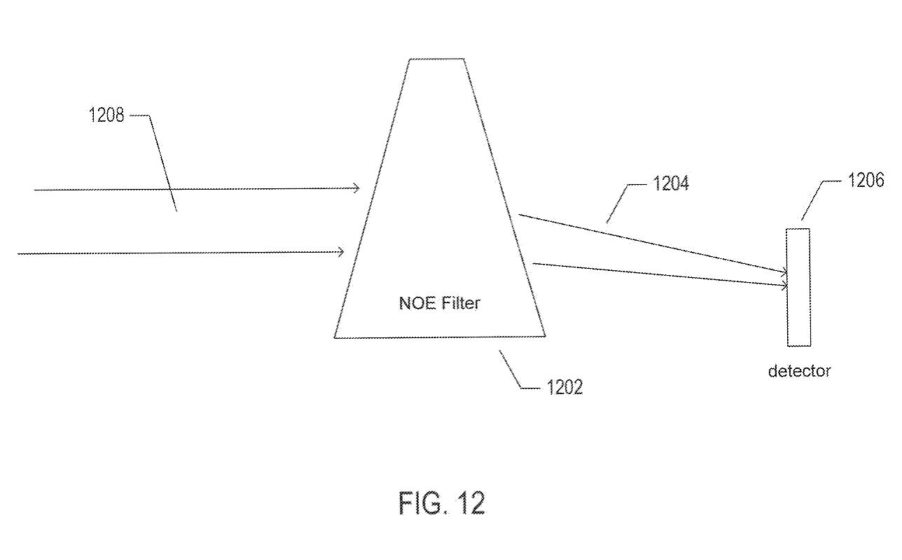

The various different NOE implementations to which the current application is directed have many different uses within a variety of different optical systems. FIG. 12 illustrates one example application for a semiconductor-based NOE. A semiconductor-based NOE 1202 can be used as a very effective filter that transmits 1204 only light above a cutoff wavelength to a detector 1206, blocking light below the cutoff wavelength of an incident beam 1208.

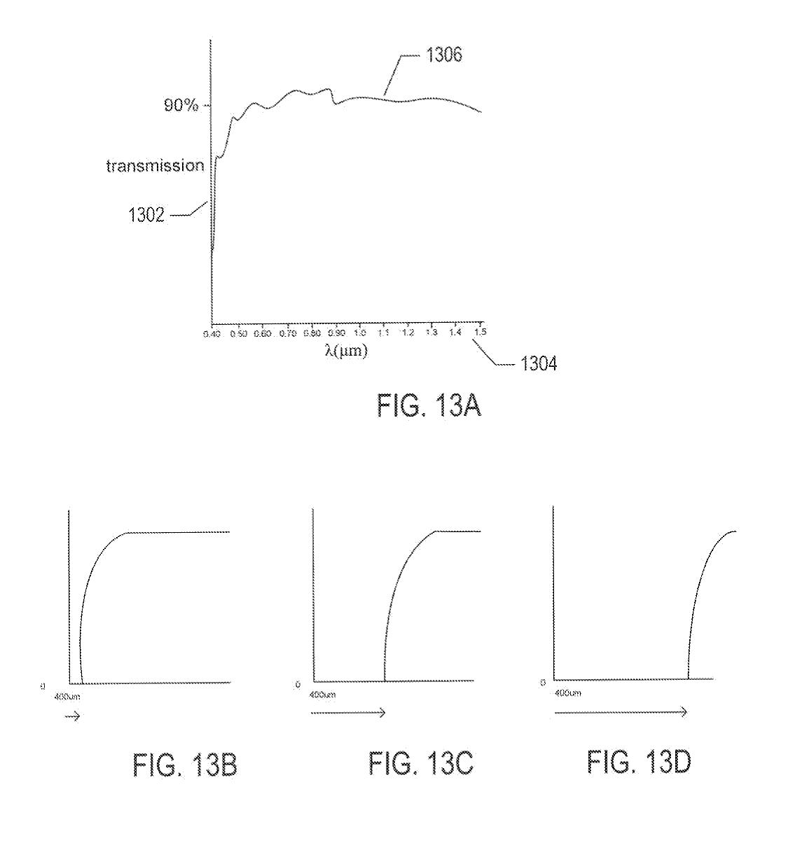

FIGS. 13B-D illustrate transmission of electromagnetic radiation by a semiconductor-based NOE with respect to wavelength. In FIG. 13A, the vertical axis represents the percent of incident light transmitted by the NOE and the horizontal axis 1304 represents wavelength. As can be seen from the plotted transmission curve 1306, the semiconductor-based NOE transmits about 90 percent of incident light with wavelengths above 500 nm and almost completely blocks incident light with wavelengths below 400 nm. As one example, a ZnSe NOE exhibits Urbach tail-function blocking to one part in 10¹⁴ at wavelengths below 480 nm. The curve is extremely steep, with the difference in wavelength between fully blocked and significantly transmitted light separated by two nanometers or less. In other cases, the difference in wavelength between fully blocked and significantly transmitted light separated by five nanometers or less. This curve is obtained from actual experimental data, and clearly shows the binary-transmissibility characteristic of a semiconductor-based NOE. As shown in FIGS. 13B-D, the semiconductor-based NOE can be differently doped to place the cutoff wave number, represented by the intersection of the nearly vertical transmission curve and horizontal axis, to various desired wavelengths within the visible and near infrared portions of the electromagnetic spectrum.

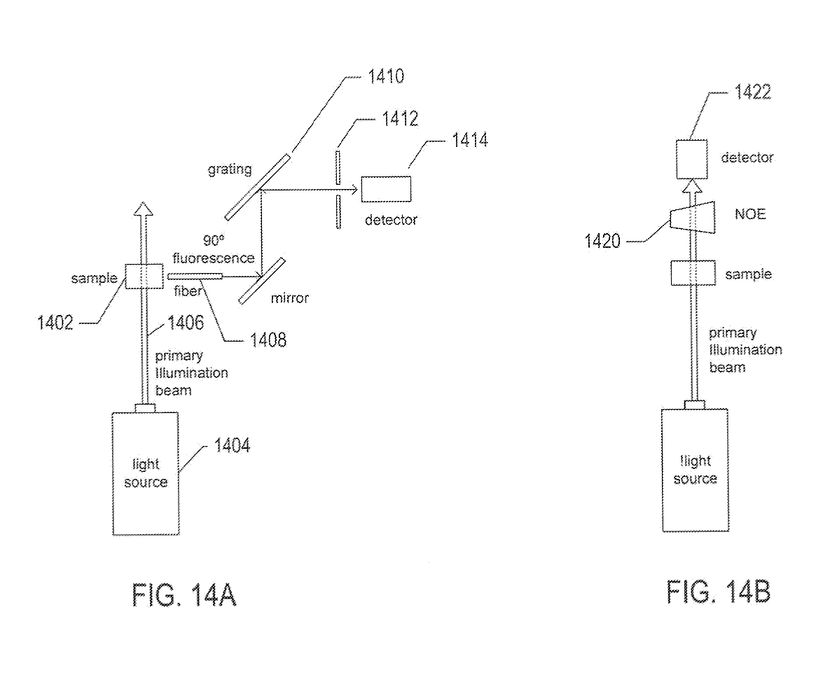

FIGS. 14A-B illustrate one possible application of a semiconductor-based NOE used as a filter. FIG. 14A shows a conventional bulk-fluorescence spectrometer. A fluorophore-labeled sample 1402 is illuminated by an excitation light source 1404 that produces a primary illumination beam 1406. Fluorescent emission from the sample enters an optical fiber 1408 disposed at approximately a 90° angle to the primary illumination beam, with a grating 1410 and slit 1412 used to select a particular fluorescence wavelength range for detection by a detector 1414. The 90° orientation of the optical fiber 1408 ensures that a minimum amount of the primary illumination beam ends up impinging on the detector. However, the 90° orientation of the optical fiber 1408 also ensures that the numerical aperture of the fluorescent-emission-detection subsystem is quite small. The small numerical aperture for the fluorescence-emission-detection subsystem represents a deliberate tradeoff in decreased magnitude of the accessed fluorescence-emission signal for an even greater decrease in excitation-source photons that reach the detector from the primary illumination beam.

FIG. 14B shows a much simpler fluorescent-emission spectrometer made possible by a semiconductor-based NOE. In the simpler NOE-based fluorescence-emission spectrometer, the NOE 1420 can be used to filter emission from the sample to eliminate primary-illumination-source UV light but directly transmit fluorescent emission from sample fluorophores to the detector. Because the semiconductor-based NOE is a highly efficient filter, as discussed above with reference to FIGS. 13A-D, and has a high etendue, a suitably-doped NOE that transmits fluorescent emission but block light from the primary illumination source can be placed directly in the primary-illumination-source-to-detector path to transmit only fluorescent emission to the detector 1422. This provides for a much larger numerical aperture for the fluorescence-emission-detection subsystem comprising the semiconductor-based NOE and detector 1422.

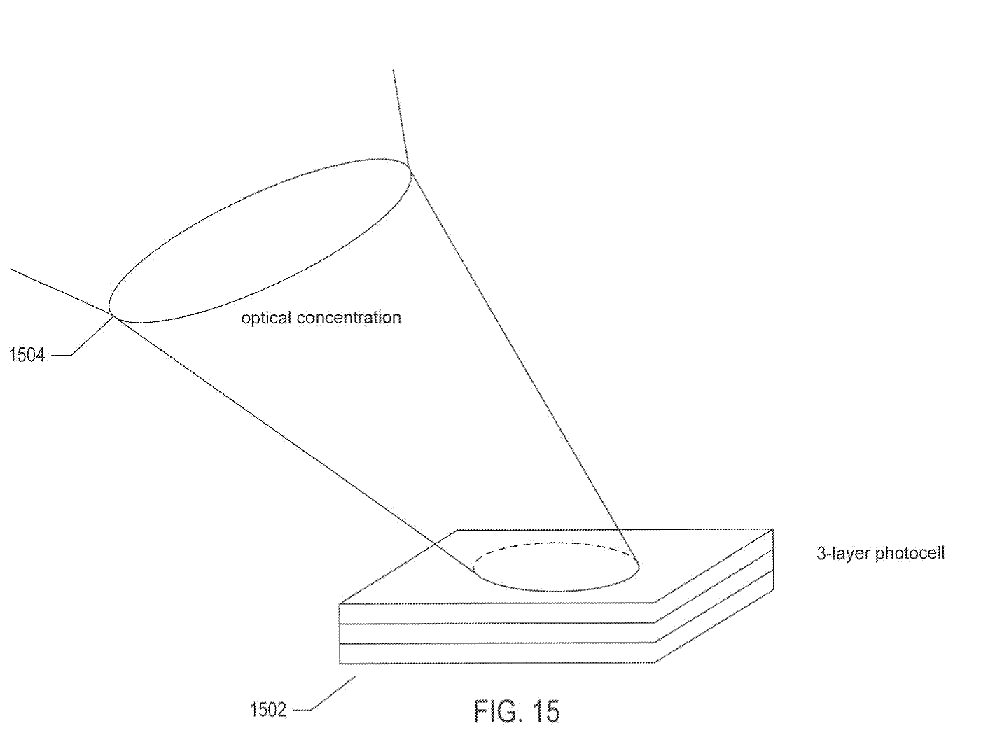

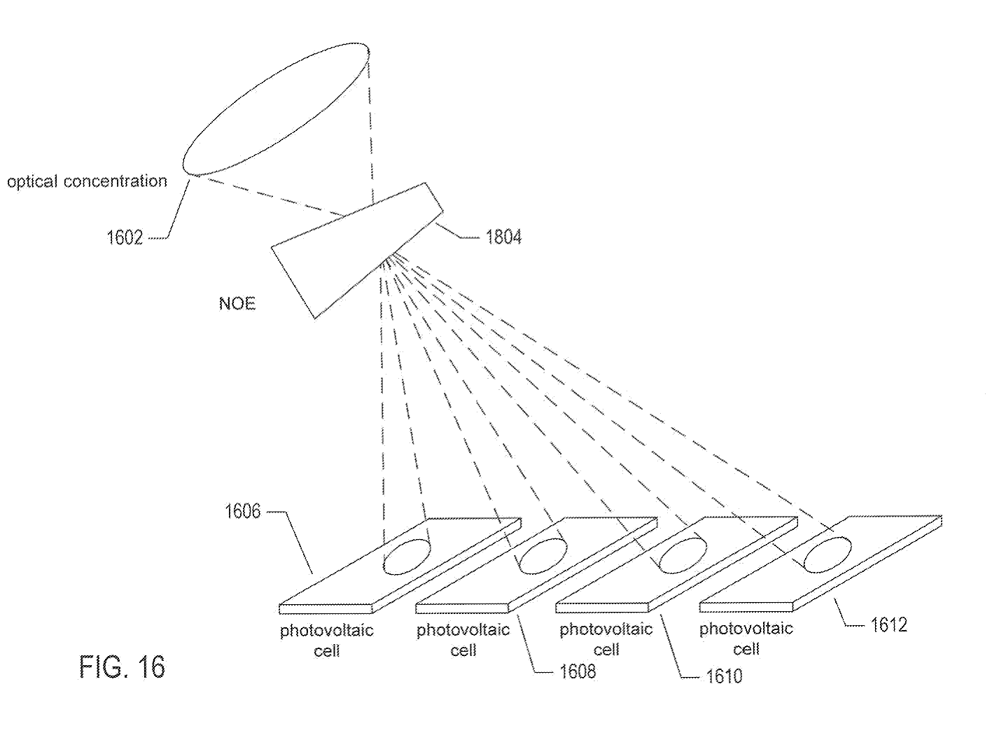

FIGS. 15 and 16 illustrate a second application for semiconductor-based NOEs to which the current application is directed. FIG. 15 illustrates an example of a currently available solar-energy technology. A three-layer photovoltaic cell 1502 receives concentrated sunlight from an optical-concentration subsystem 1504 and converts the impinging sunlight into electrical energy. Layered photovoltaic-cell systems are currently employed because, in general, a single photovoltaic cell cannot efficiently harvest energy across the visible-light spectrum. Instead, three layers are employed to cover the visible-light spectrum, each fabricated to efficiently harvest energy from portions of the visible-light spectrum different from those at which the other photovoltaic cells efficiently harvest energy.

There are, unfortunately, many inefficiencies associated with layered photovoltaic cells. First, the semiconductor material of the top-most photovoltaic cell filters a portion of the impinging sunlight that it does not convert to electrical energy, lowering the efficiency of the underlying photovoltaic cells. Furthermore, each photovoltaic cell includes electrically conductive pathways and circuitry needed to transmit electrical energy out of the voltaic cells to batteries or directly to an electric grid, and this circuitry may significantly interfere with light transmission to lower layers. In layered photovoltaic cells, the lattice constants of the crystalline structures of the layers needs to be precisely matched, limiting the materials that can be used for the different layers. Finally, the photovoltaic cells are electrically interconnected in serial fashion, limiting the overall efficiency of the layered photovoltaic solar cell to the efficiency of the minimally-efficient layer in the stack.

FIG. 16 illustrates application of a semiconductor-based NOE to the solar-energy harvesting and conversion domain. As shown in FIG. 16, an optical solar concentration subsystem 1602 concentrates light onto a semiconductor-based NOE 1604. Because the semiconductor-based NOE features a much higher etendue than similarly shaped glass prisms, the semiconductor-based NOE is capable of harvesting much greater radiant flux from the concentration subsystem than a glass prism or other traditional optical element. Furthermore, because the semiconductor-based NOE is characterized by much higher dispersion than glass-based optical elements, the semiconductor-based NOE is able to spread the visible light over a much greater angle so that the harvested light energy can be deposited directly onto photovoltaic cells maximally responsive to the particular ranges of wavelength. For example, as shown in FIG. 16, a first photovoltaic cell 1606 may receive 400 nm-475 nm wavelength light, the second photovoltaic cell 1608 may receive light with wavelength between 475 nm and 550 nm, the third photovoltaic cell 1610 may receive light with wavelength between 550 nm and 650 nm, and the final photovoltaic cell 1612 may receive light with wavelength greater than 650 nm. Because of the ability of the semiconductor-based NOE to disperse incident light over much wider angles than traditional optical elements, the photovoltaic calls can be directly illuminated, rather than stacked, as in the stacked photovoltaic cell shown in FIG. 15. In one implementation, a NOE disperses visible light over an angle of 20°, while a similarly sized and shaped glass prism disperses light over an angle of approximately 1°. Furthermore, the NOE is far more tolerant to misalignment in tracking of the sun than an equivalent glass prism. This allows the photovoltaic cells to be electrically connected in parallel, rather than serially, which removes the problem of filtering of the incident beam by upper photovoltaic layers and the concomitant decrease in the efficiency of lower photovoltaic layers. Additionally, the light emitted from the NOE over an angle of 20°, versus an angle of 1° for a typical glass prism, is far more spectrally pure, for the NOE than for the glass prism. In one example, in the dispersed light, application of a red-light transmissive filter that blocks other visible wavelengths reveals that the red light emitted from the NOE occurs within 0.5° of the red-wavelength end of the dispersed light, while, in the case of light emitted from a glass prism, the red light occurs over half of the 1° of the dispersion angle. The high spectral purity of light emitted from the NOE results in a very desirable ability to direct wavelength bands precisely to the particular photovoltaic cells suitable for transforming the incident light into electricity.

Although the present invention has been described in terms of particular embodiments, it is not intended that the invention be limited to these embodiments. Modifications within the spirit of the invention will be apparent to those skilled in the art. For example, as discussed above, NOEs to which the current application is directed can have a variety of different shapes and sizes and can be manufactured from many different possible semiconductor materials doped with many different types of dopants. Numerous different types of anti-reflective coatings can be used to achieve the stepwise increase in refractive index from the outermost coating to the innermost coating, discussed above. NOEs to which the current application is directed are characterized by binary transmissibility, high etendue, high dispersion, and high transmissibility in selected portions of the visible and infrared spectra.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An optical component of an optical system, the optical component comprising:
a semiconductor material that transmits 90% or greater of incident visible light above a threshold wavelength in the ultraviolet or visible electromagnetic-radiation band;
an input optical surface and an output optical surface; and
multiple anti-reflective coatings layered on the input optical surface and the output optical surface, the multiple anti-reflective coatings having refractive indexes greater than the refractive index of a medium external to the optical component and less than the refractive index of the semiconductor material, the refractive indexes of the multiple anti-reflective coatings increasing from outermost to innermost so that no adjacent coating layers have a difference in refractive index greater than 0.1.

2. The optical component of claim 1 wherein the semiconductor material is a binary II-VI semiconductor material.

3. The optical component of claim 2 wherein the semiconductor material is one of:
ZnSe;
ZnS.

4. The optical component of claim 1 wherein the semiconductor material is a binary III-V semiconductor material.

5. The optical component of claim 1 wherein the semiconductor material is ONE OF:
ThBrI₂;
IV-VI telluride oxides;
alkali yttrium oxides;
I-III-VI lanthanide oxides; and
ZnCdTe₂.

6. The optical component of claim 1 wherein the semiconductor material is doped with one of an acceptor dopant and a donor dopant.

7. The optical component of claim 1 wherein the type and amount of dopant within the semiconductor material determines the threshold wavelength below which incident light is blocked and above which incident light is transmitted.

8. The optical component of claim 1 wherein the optical component has an etendue at least two times greater than the etendue of a similarly sized and shaped glass optical component.

9. The optical component of claim 1 wherein the median index of refraction for the multiple anti-reflective coatings is approximately equal to the square root of the refractive index of the semiconductor material.

10. The optical component of claim 1 wherein the optical component receives incident light at near the Brewster's angle for glass.

11. The optical component of claim 1 wherein the optical component disperses visible incident light over an angle at least three times greater than the angle over which a similarly sized and similarly shaped glass optical element disperses visible light.

12. The optical component of claim 1 wherein the optical component disperses visible incident light over an angle at least ten times greater than the angle over which a similarly sized and similarly shaped glass optical element disperses visible light.

13. The optical component of claim 1 wherein the optical component disperses visible incident light over an angle at least ten times greater than the angle over which a similarly sized and similarly shaped glass optical element disperses visible light.

14. The optical component of claim 1 wherein the rate of change of etendue with respect to the wavelength of incident light for the optical component is greater than 10 times the rate of change of etendue with respect to the wavelength of incident light for a similarly sized and similarly shaped glass optical component.

15. The optical component of claim 1 wherein, at wavelengths 5 nm or more below the threshold wavelength, the optical element transmits less than one part in 10¹² of the light transmitted at wavelengths 5 nm or more above the threshold wavelength.

16. The optical component of claim 1 wherein, at wavelengths 2 nm or more below the threshold wavelength, the optical element transmits less than one part in 10¹² of the light transmitted at wavelengths 2 nm or more above the threshold wavelength.

17. The optical component of claim 1 wherein, at wavelengths 5 nm or more below the threshold wavelength, the optical element transmits less than one part in 10¹⁴ of the light transmitted at wavelengths 5 nm or more above the threshold wavelength.

18. The optical component of claim 1 wherein, at wavelengths 2 nm or more below the threshold wavelength, the optical element transmits less than one part in 10¹⁴ of the light transmitted at wavelengths 2 nm or more above the threshold wavelength.

19. An optical element comprising:
a semiconductor material that transmits 90% or greater of incident visible light above a first threshold wavelength in the ultraviolet or visible electromagnetic-radiation band and that transmits less than one part in 10¹² of incident visible and UV light below a second threshold wavelength in the ultraviolet or visible electromagnetic-radiation band, the first and second thresholds separated in wavelength by less than 5 nm;
an input optical surface and an output optical surface; and
multiple anti-reflective coatings layered on the input optical surface and the output optical surface, the multiple anti-reflective coatings having refractive indexes greater than the refractive index of a medium external to the optical component and less than the refractive index of the semiconductor material, the refractive indexes of the multiple anti-reflective coatings increasing from outermost to innermost so that no adjacent coating layers have a difference in refractive index greater than 0.15.

20. The optical element of claim 19 wherein the input and output optical surfaces are each one of planar;
convexly curved; and
concavely curved.
